(19) United States
(12) Patent Application Publication
(10) Pub. No.: US 2008/0137001 A1
(43) Pub. Date: Jun. 12, 2008

(54) Backlight module with flat lamp and liquid crystal display having same

(75) Inventor: Ke Li, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/001,617

(22) Filed: Dec. 11, 2007

(30) Foreign Application Priority Data
Dec. 11, 2006 (TW) 95221798

(51) Int. Cl. G02F 1/13357; F21V 19/00; H01J 1/00

(52) U.S. Cl. 349/62; 362/611; 362/614

(57) ABSTRACT

An exemplary liquid crystal display (200) includes an LCD panel (22) and a backlight module (23) located adjacent to the LCD panel. The backlight module includes a light guide plate (26) and a flat lamp (27). The light guide plate includes a light incident surface (261). The flat lamp includes a plane surface (271). The plane surface of the flat lamp is adjacent and substantially parallel to the light incident surface of the light guide plate.

### FIELD OF THE INVENTION

The present invention relates to backlight modules such as those used in liquid crystal displays (LCDs); and more particularly to a backlight module with a flat lamp, and an LCD with the backlight module installed therein.

### GENERAL BACKGROUND

LCDs are commonly used as displays for compact electronic apparatuses. This is because they not only provide good quality images with little power consumption, but also they are very thin. The liquid crystal in a liquid crystal display does not emit any light itself. The liquid crystal has to be lit by a light source so as to clearly and sharply display text and images. Thus, a backlight module is generally needed for a liquid crystal display.

Referring to FIG. 5, a typical LCD 100 includes an LCD panel 12 and a backlight module 13. The backlight module 13 provides a planar light source to illuminate the LCD panel 12.

The backlight module 13 includes a frame 15, a set of optical films 180, a light guide plate (LGP) 16, two lamps 17, a lamp reflector 18, two rubber pieces 19, and a reflective film 190. The LGP 16 has a rectangular shape, and includes a light incident surface 161, a top light emitting surface 162 adjoining the light incident surface 161, and a bottom surface 163 adjoining the light incident surface 161. Each rubber piece 19 has two openings 197 corresponding with the two lamps 17.

Referring also to FIGS. 6 and 7, a cross-section of each lamp 17 is circular, and a cross-section of the lamp reflector 18 is generally U-shaped. A height of the lamp reflector 18 is 8.08 mm (millimeters). A diameter of each lamp 17 is 2.4 mm, and a length of the lamp 17 is 347 mm (not shown). The two lamps 17 are separated by a gap of 1.7 mm. Thus a total height spanned by the combination of the two lamps 17 is 6.5 mm. The four openings 197 of the two rubber pieces 19 receive corresponding ends of the two lamps 17. The lamp reflector 18 receives the lamps 17 with the rubber pieces 19. The lamp reflector 18 is disposed adjacent to the light incident surface 161 of the LGP 16. The reflective film 190 is disposed adjacent to the bottom surface 163 of the LGP 16. The set of optical films 180 is disposed adjacent to the light emitting surface 162 of the LGP 16. The frame 15 receives the set of optical films 180, the LGP 16, the reflective film 190, and the lamp reflector 18.

The two lamps 17 need to be spaced apart a certain distance in order to prevent heat generated by each lamp 17 unduly heating up the other lamp 17. Therefore when the size of the lamp reflector 18 is constant, the diameters of the lamps 17 are limited to a certain maximum safe size. This means a total light-emitting area of the lamps 17 is also limited. Accordingly, the brightness of light provided by the backlight module 13 is limited. This can be particularly problematic in the case of a large sized LCD 100 having a large LCD panel 12 and requiring a large backlight module 13. In such case, the backlight module 13 may not be able to provide sufficient brightness to illuminate the LCD panel 12.

What is needed, therefore, is a backlight module and an LCD incorporating the backlight module which can overcome the above-described deficiencies.

### SUMMARY

A backlight module includes a light guide plate and a flat lamp. The light guide plate includes a light incident surface. The flat lamp includes a plane surface. The plane surface of the flat lamp is adjacent and substantially parallel to the light incident surface of the light guide plate.

A liquid crystal display includes an LCD panel and a backlight module located adjacent to the LCD panel. The backlight module includes a light guide plate and a flat lamp. The light guide plate includes a light incident surface. The flat lamp includes a plane surface. The plane surface of the flat lamp is adjacent and substantially parallel to the light incident surface of the light guide plate.

Other aspects, novel features, and advantages will become more apparent from the following detailed description when taken in conjunction with the accompanying drawings.

### BRIEF DESCRIPTION OF THE DRAWINGS

FIG. 1 is an exploded, isometric view of an LCD according to a preferred embodiment of the present invention, the LCD including a backlight module.

FIG. 2 is an enlarged view of a circled portion II of FIG. 1.

FIG. 3 is an assembled view of the backlight module of FIG. 1.

FIG. 4 is an enlarged, cross-sectional view taken along line IV-IV of FIG. 3.

FIG. 5 is an exploded, isometric view of a conventional LCD, the LCD including a backlight module.

FIG. 6 is an assembled view of the backlight module of FIG. 5.

FIG. 7 is an enlarged, cross-sectional view taken along line VII-VII of FIG. 6.

### DETAILED DESCRIPTION OF PREFERRED EMBODIMENTS

Reference will now be made to the drawings to describe the preferred and exemplary embodiments in detail.

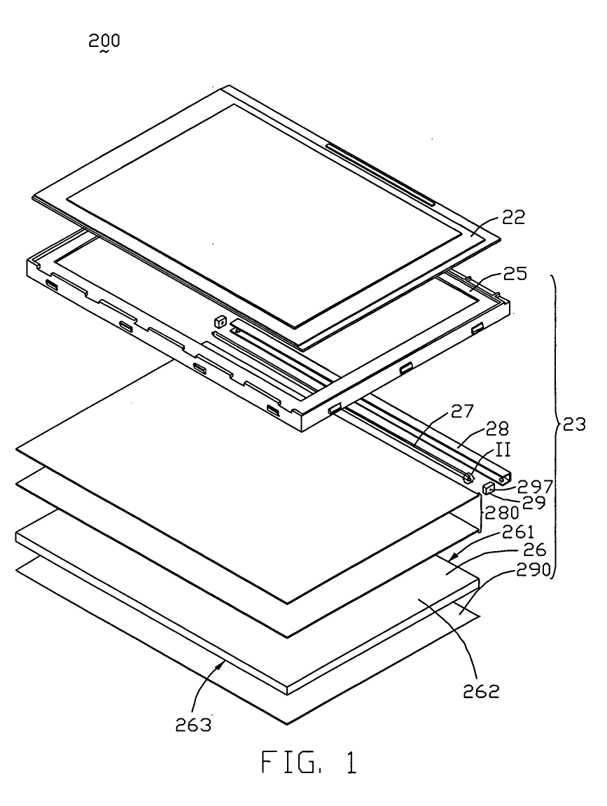

Referring to FIG. 1, an LCD according to a preferred embodiment of the present invention is shown. The LCD 200 includes an LCD panel 22 and a backlight module 23. The backlight module 23 provides a planar light source to illuminate the LCD panel 22.

The backlight module 23 includes a frame 25, a set of optical films 280, a light guide plate (LGP) 26, a flat lamp 27, a lamp reflector 28, two rubber pieces 29, and a reflective film 290. Each rubber piece 29 has an opening 297 corresponding with an end of the flat lamp 27. The LGP 26 has a rectangular shape, and includes a light incident surface 261, a top light emitting surface 262 adjoining the light incident surface 261, and a bottom surface 263 adjoining the light incident surface 261.

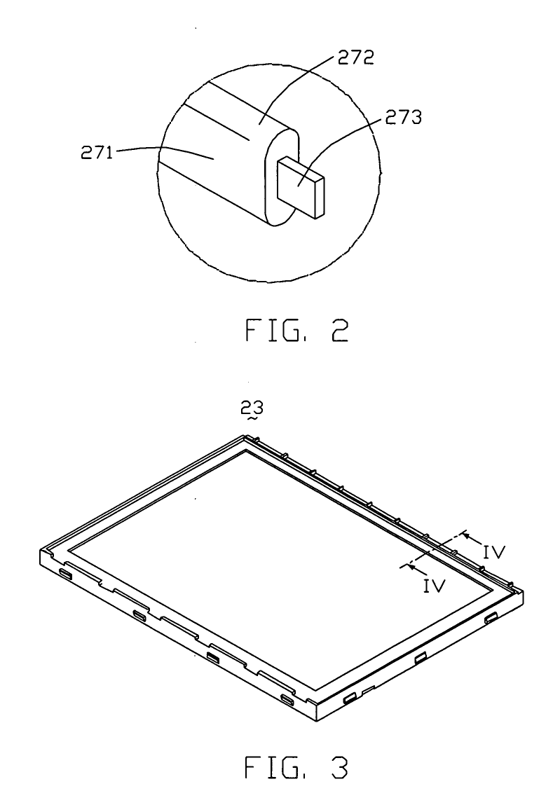

FIG. 2 is an enlarged view of a circled portion II of FIG. 1. The flat lamp 27 includes two rectangular surfaces 271 at two opposite sides thereof respectively, and two semicircle surfaces 272 at another two opposite sides thereof respectively. The two rectangular surfaces 271 and two semicircle surfaces 272 are arranged end-to-end to cooperatively form a generally four-surface closed lamp. Each end of the flat lamp 27 is coupled with an electrode 273. A cross-section of the electrode 273 is rectangular. The flat lamp 27 may be a cold cathode fluorescent lamp.

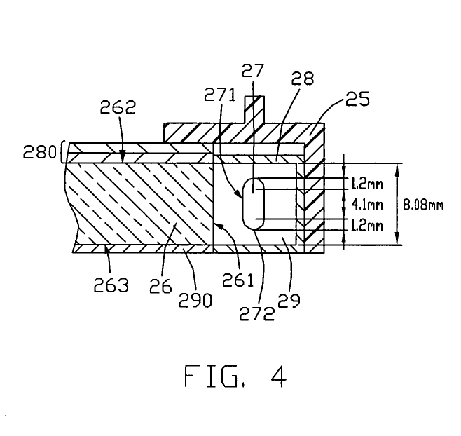

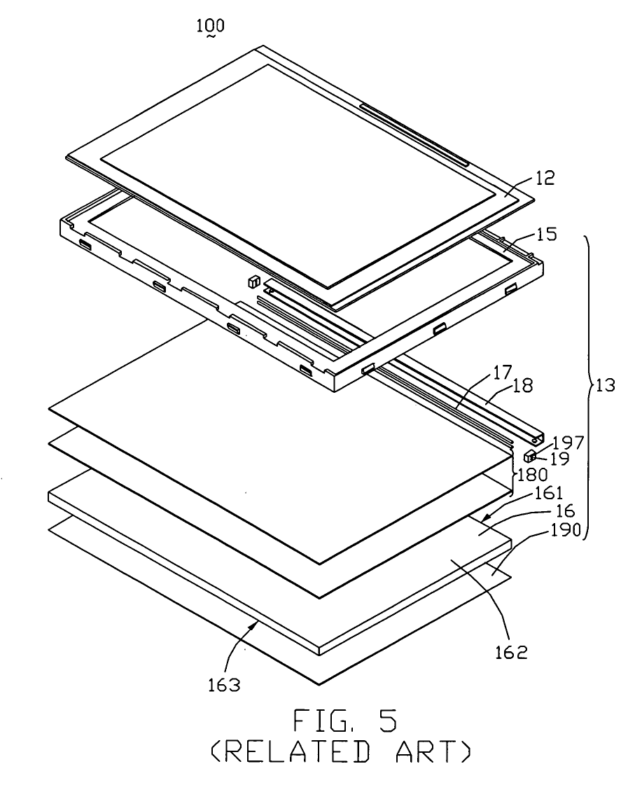

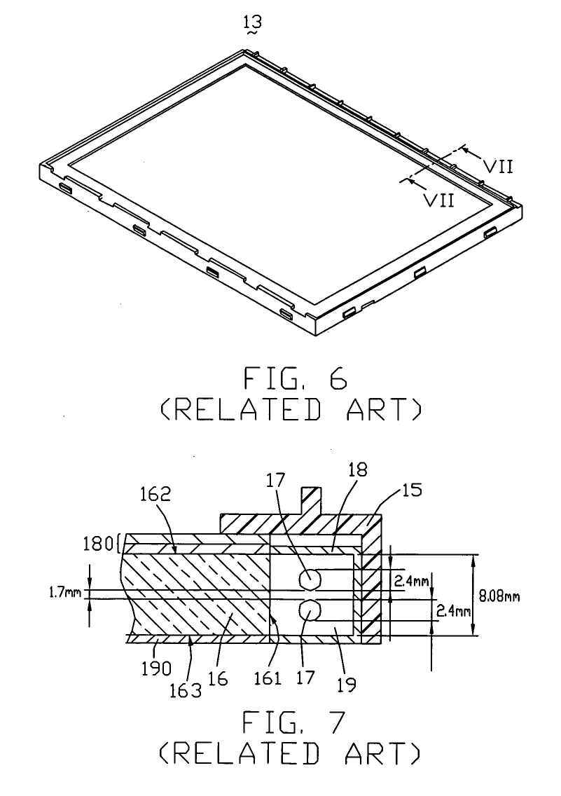

Referring also to FIGS. 3 and 4, a cross-section of the lamp reflector 28 is generally U-shaped. A height of the lamp reflector 28 is 8.08 mm. A height of the rectangular surface 271 is 4.1 mm, and a length of the rectangular surface 271 is 347 mm (not shown). A radius of the semicircle surface 272 is 1.2 mm. Thus a maximum height of the flat lamp 17 is 6.5 mm. The two openings 297 of the two rubber pieces 29 receive the ends of the flat lamp 27. The lamp reflector 28 receives the flat lamp 27 with the rubber pieces 29. The lamp reflector 28 is disposed adjacent to the light incident surface 261 of the LGP 26. One of the rectangular surfaces 271 of the flat lamp 27 is parallel to the light incident surface 261 of the LGP 26. The reflective film 290 is disposed adjacent to the bottom surface 263 of the LGP 26. The set of optical films 280 is disposed adjacent to the light emitting surface 262 of the LGP 26. The frame 25 receives the set of optical films 280, the LGP 26, the reflective film 290, and the lamp reflector 28.

The size of the flat lamp 27 of the backlight module 23 is substantially equal to the total size of the combination of two lamps 17 of the above-described conventional backlight module 13. However, a light-emitting area of the rectangular surface 271 of the flat lamp 27 which is parallel to and directly faces the light incident surface 261 is much larger than that of a corresponding area or areas of the two conventional lamps 17. Therefore the flat lamp 27 efficiently provides light directly entering the light incident surface 261, and the backlight module 23 can provide ample brightness to illuminate the LCD panel 22. This is particularly advantageous when the LCD 200 is a large sized one. Furthermore, there is no light energy wasted in heating up an adjacent lamp 17, as is the case with the conventional backlight module 13. Moreover, there is no associated risk of the adjacent lamp 17 becoming overheated, as is the case with the conventional backlight module 13.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module, comprising:
a light guide plate comprising a light incident surface; and
a flat lamp comprising a plane surface;
wherein the plane surface of the flat lamp is adjacent and substantially parallel to the light incident surface of the light guide plate.

2. The backlight module as claimed in claim 1, wherein the flat lamp is an elongate flat lamp.

3. The backlight module as claimed in claim 1, wherein the plane surface of the flat lamp is a rectangular surface.

4. The backlight module as claimed in claim 3, wherein the flat lamp comprises another rectangular surface, and two curved surfaces, wherein the two rectangular surfaces are parallel to each other at opposite sides of the flat lamp, and the two curved surfaces are symmetrical to each other at opposite sides of the flat lamp.

5. The backlight module as claimed in claim 4, wherein a height of the rectangular surface is approximately 4.1 mm.

6. The backlight module as claimed in claim 5, wherein a length of the rectangular surface is approximately 347 mm.

7. The backlight module as claimed in claim 1, wherein each end of the flat lamp has an electrode extending therefrom.

8. The backlight module as claimed in claim 7, wherein a cross-section of the electrode is rectangular.

9. The backlight module as claimed in claim 4, wherein each of the curved surfaces of the flat lamp is semicylindrical.

10. The backlight module as claimed in claim 9, wherein a radius of the semicylindrical surface is approximately 1.2 mm.

11. The backlight module as claimed in claim 1, wherein the flat lamp is a cold cathode fluorescent lamp.

12. The backlight module as claimed in claim 1, further comprising two rubber pieces, wherein each rubber piece comprises an opening engagingly receiving a respective end of the flat lamp.

13. The backlight module as claimed in claim 1, further comprising a lamp reflector, wherein the lamp reflector receives the flat lamp therein.

14. The backlight module as claimed in claim 13, wherein a cross-section of the lamp reflector is generally U-shaped.

15. The backlight module as claimed in claim 14, wherein a height of the lamp reflector is approximately 8.08 mm.

16. A liquid crystal display, comprising:
a liquid crystal display panel; and
a backlight module located adjacent to the liquid crystal display panel, the backlight module comprising:
a light guide plate comprising a light incident surface; and
a flat lamp comprising a plane surface;
wherein the plane surface of the flat lamp is adjacent and substantially parallel to the light incident surface of the light guide plate.

17. The liquid crystal display as claimed in claim 16, wherein the flat lamp is an elongate flat lamp.

18. The liquid crystal display as claimed in claim 16, wherein the plane surface of the flat lamp is a rectangular surface.

0. The liquid crystal display as claimed in claim 18, wherein the flat lamp further comprises another rectangular surface, and two curved surfaces, wherein the two rectangular surfaces are parallel to each other at opposite sides of the flat lamp, and the two curved surfaces are symmetrical to each other at opposite sides of the flat lamp.
